(19) United States
(12) Patent Application Publication
(10) Pub. No.: US 2023/0182835 A1
(43) Pub. Date: Jun. 15, 2023

(54) CONFIGURABLE TRAILER

(71) Applicant: Anthony W. Phelps, Colorado Springs, CO (US)

(72) Inventor: Anthony W. Phelps, Colorado Springs, CO (US)

(21) Appl. No.: 18/055,559

(22) Filed: Nov. 15, 2022

Related U.S. Application Data
(60) Provisional application No. 63/289,359, filed on Dec. 14, 2021.

(51) Int. Cl. B62D 63/06; B60P 3/34

(52) U.S. Cl. CPC B62D 63/061; B60P 3/34

(57) ABSTRACT

A configurable trailer system which includes a chassis supported by one or more axles and any combination of an enclosed trailer, a camper, a livestock trailer, a dump bed and an open-sided trailer. The chassis includes a support surface and, at corners of the support surface, a plurality of locks. Each of the enclosed trailer, camper, livestock trailer, dump bed and open-sided trailer includes a plurality of corner castings configured to selectively and securely couple with the locks. A method for configuring the trailer system includes placing a first one of an enclosed trailer, a camper, a livestock trailer, a dump bed and an open-sided trailer on the chassis and locking to the chassis by engaging the locks with corner castings provided to corners of the first one of the enclosed trailer, camper, livestock trailer, dump bed and open-sided trailer.

### CROSS-REFERENCE TO RELATED APPLICATIONS

This application claims the priority benefit of U.S. Provisional Application No. U.S. 63/289,359 filed on 14 Dec. 2021, pending, which is incorporated herein by reference in its entirety.

### SUMMARY

The disclosure describes a configurable trailer system. The system includes a chassis and any combination of an enclosed trailer, a camper, a livestock trailer, a dump bed and an open-sided trailer. The chassis is supported by one or more axles and includes a support surface. At corners of the support surface the chassis includes a plurality of locks. Each of the enclosed trailer, camper, livestock trailer, dump bed and open-sided trailer includes a plurality of rectangular prisms configured to selectively and securely couple with the locks.

The disclosure also describes another configurable trailer system which includes a camper and a chassis supported by one or more axles. The camper includes a plurality of corner castings each having top, bottom, left side, right side, front and rear surfaces with a plurality of openings in the surfaces. The chassis includes a surface configured to support the camper and, at corners of the surface, a plurality of locks configured to selectively and securely couple the camper to the chassis through engagement of the locks with the corner castings.

The disclosure also describes another configurable trailer system. The chassis is supported by one or more axles and includes a support surface and, at corners of the support surface, a plurality of locks. The camper includes a plurality of corner castings configured to selectively and securely couple with the locks.

### BRIEF DESCRIPTION OF THE FIGURES

The summary above, as well as the following detailed description of illustrative embodiments, is better understood when read in conjunction with the appended drawings. For the purpose of illustrating the disclosure, example constructions are shown in the drawings. However, the disclosure is not limited to specific methods and instrumentalities disclosed herein. Moreover, those having ordinary skill in the art will understand that the drawings are not to scale. Wherever possible, like elements have been indicated by identical numbers.

Embodiments of the disclosure will now be described, by way of example only, with reference to the following diagrams wherein:

FIG. 1 illustrates a side view of an example chassis.

FIG. 2 illustrates a rear view of the example chassis of FIG. 1.

FIG. 3 illustrates a top view of the example chassis of FIGS. 1 & 2.

FIG. 4 illustrates a perspective view of the example chassis of FIGS. 1-3 with a detail view of an example lock.

FIG. 5 illustrates a side view of an example enclosed trailer.

FIG. 6 illustrates a rear view of the enclosed trailer of FIG. 5.

FIG. 7 illustrates a top view of the example enclosed trailer of FIGS. 5 & 6.

FIG. 8 illustrates a perspective view of the example enclosed trailer of FIGS. 5-7 with a detail view of an example corner casting.

FIG. 9 illustrates a perspective view of the example enclosed trailer of FIGS. 5-8 and the example chassis of FIGS. 1-4 in an alignment suitable for coupling.

FIG. 10 illustrates a top view of the example enclosed trailer of FIGS. 5-8 mounted on the example chassis of FIGS. 1-4.

FIG. 11 illustrates a side view of the example enclosed trailer of FIGS. 5-8 mounted on the example chassis of FIGS. 1-4.

FIG. 12 illustrates a perspective view of the example enclosed trailer of FIGS. FIGS. 5-8 mounted on the example chassis of FIGS. 1-4.

FIG. 13 illustrates a rear view of the example enclosed trailer of FIGS. FIGS. 5-8 mounted on the example chassis of FIGS. 1-4.

FIG. 14 illustrates a perspective view of an example camper and the example chassis of FIGS. 1-4 in an alignment suitable for coupling.

FIG. 15 illustrates a side view of the camper of FIG. 14 mounted on the example chassis of FIGS. 1-4.

FIG. 16 illustrates a perspective view of an example livestock trailer and the example chassis of FIGS. 1-4 in an alignment suitable for coupling.

FIG. 17 illustrates a side view of the livestock trailer of FIG. 16 mounted on the example chassis of FIGS. 1-4.

FIG. 18 illustrates a perspective view of an example dump bed and the example chassis of FIGS. 1-4 in an alignment suitable for coupling.

FIG. 19 illustrates a side view of the dump bed of FIG. 18 mounted on the example chassis of FIGS. 1-4.

FIG. 20 illustrates a side view of the dump bed of FIGS. 18 & 19 mounted on the example chassis of FIGS. 1-4 and in a dumping configuration.

### DETAILED DESCRIPTION

The following detailed description illustrates embodiments of the disclosure and manners by which they can be implemented. Although the best mode of carrying out disclosed systems and methods has been described, those of ordinary skill in the art would recognize that other embodiments for carrying out or practicing disclosed systems and methods are also possible.

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

Typically, people have a separate trailer with one or more axles for each of the applications they enjoy or are responsible for. For example, a person may have a flatbed, a fifth wheel RV, two stock trailers and an enclosed trailer.

Embodiments of the disclosure provide a base flatbed trailer or chassis configured to receive and securely support any of a variety of accessory structures. Embodiments of the disclosure substantially eliminate, or at least partially address, problems in the prior art, enabling users to engage in a variety of activities with a single trailer system that requires only a single license and a single set of tires. As such, expenses as well as environmental impact from discarded tires may be reduced.

Additional aspects, advantages, features and objects of the disclosure will be made apparent from the drawings and the detailed description of the illustrative embodiments construed in conjunction with the appended claims that follow. It will be appreciated that described features are susceptible to being combined in various combinations without departing from the scope of the disclosure as defined by the appended claims.

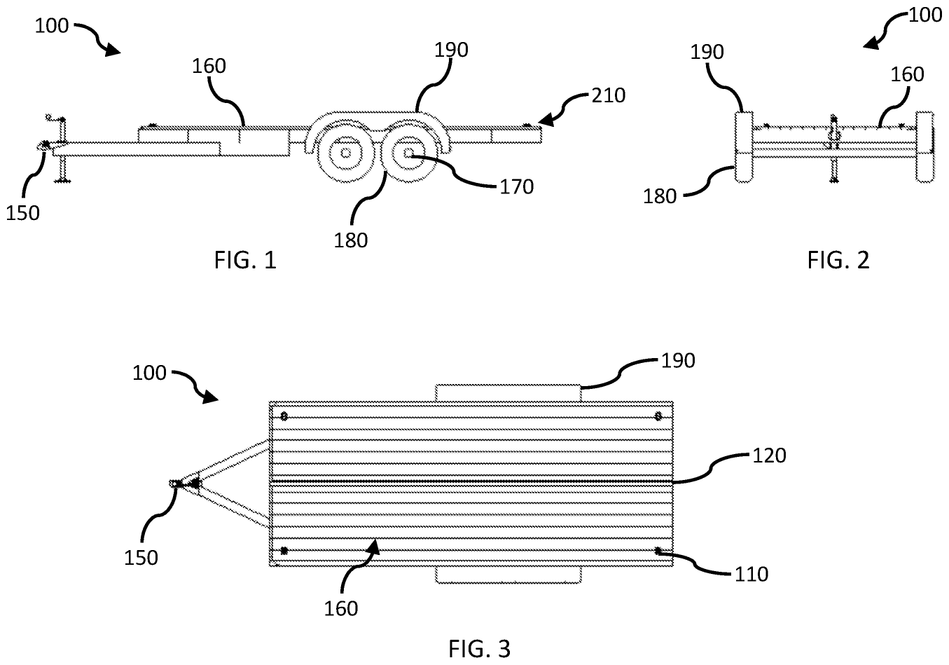

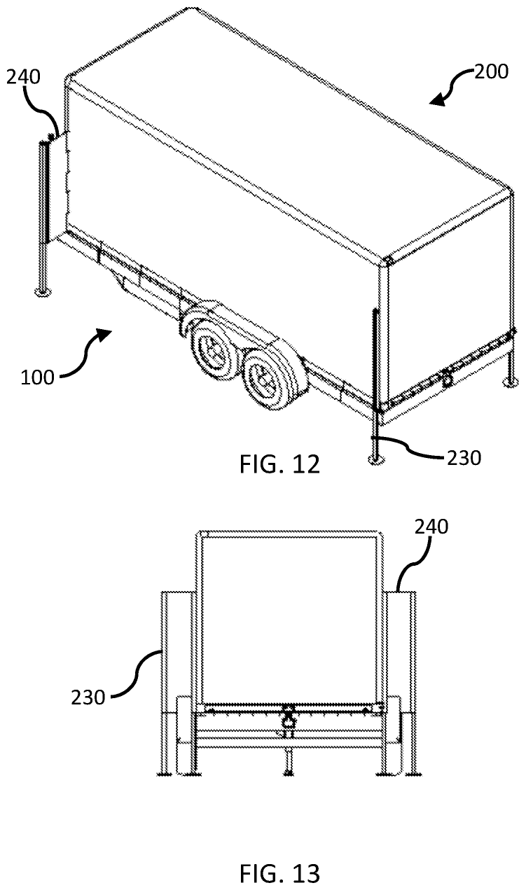

FIGS. 1-20 illustrate an example configurable trailer system. The system includes a chassis and any combination of an enclosed trailer, a camper or mobile dwelling, a livestock trailer, a dump bed and an open-sided trailer.

FIGS. 1-4 illustrate an example chassis 100. Chassis 100 is supported by one or more axles 170 and includes a support surface or deck 160 configured to support each of the combination of the enclosed trailer, camper, livestock trailer, dump bed and open-sided trailer. Axles 170 may be dead axles such that they are passive or not driven except by engagement of wheels 180 with a surface on which the wheels are rolling. Fenders 190 partially house wheels 180 to prevent interference of foreign objects therewith and to prevent kick up of hazardous debris therefrom. A tow hitch coupler 150 may extend from a front of chassis 100. In an example, chassis 100 is a flatbed trailer.

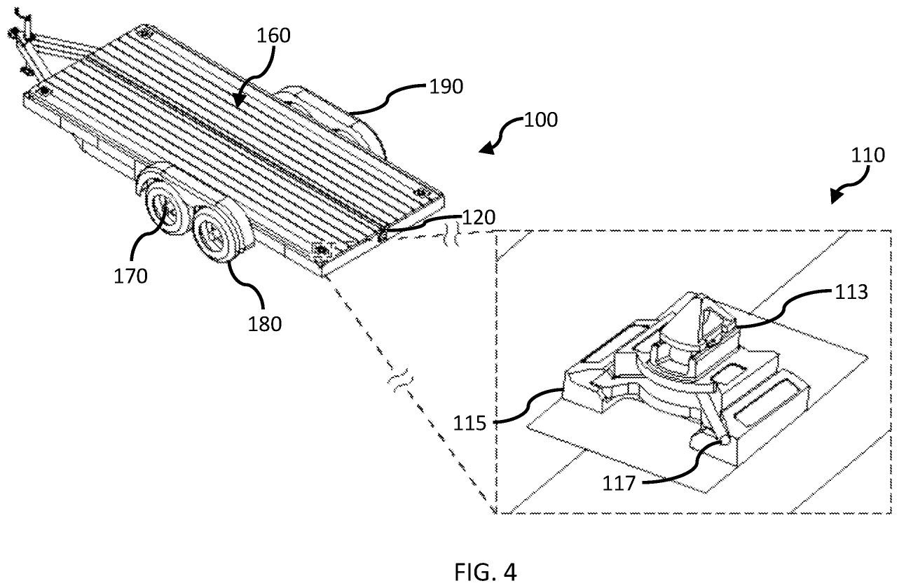

At corners of support surface 160, chassis 100 includes a number of locks configured to selectively and securely couple each of the combination of the enclosed trailer, the camper or mobile dwelling, the livestock trailer, the dump bed and the open-sided trailer to the chassis. FIG. 4 illustrates a perspective view of the example chassis of FIGS. 1-3 with a detail view of an example lock 110. Example locks include but are not limited to twist locks and Tantlinger locks. Lever 117 may be rotated or shifted from a first position to a second position to twist a cone 113. With lever 117 in the first position, cone 113 is oriented to freely pass into or from an element of the enclosed trailer, camper, livestock trailer or dump bed whereas in the second position, cone 113 is oriented to prevent its passage into or from the element. Locks 110 may be secured to chassis 100 in any of a variety of ways including by not limited to welding to support surface 160 in a surface mount or recessed and/or countersunk mounting. In an example, a base or shoe 115 is secured to chassis 110 and the bottom portion of lock 110 is slid into base 115.

A first component 120 of a sliding dovetail joint is provided to chassis support surface 160. In an example, first component 120 of the sliding dovetail joint is provided in an orientation approximately perpendicular to the one or more axles 170 or in the direction of a longitudinal axis of chassis 100 so that any of the enclosed trailer, camper, livestock trailer or dump bed can be mounted to or removed from the chassis by longitudinal translation.

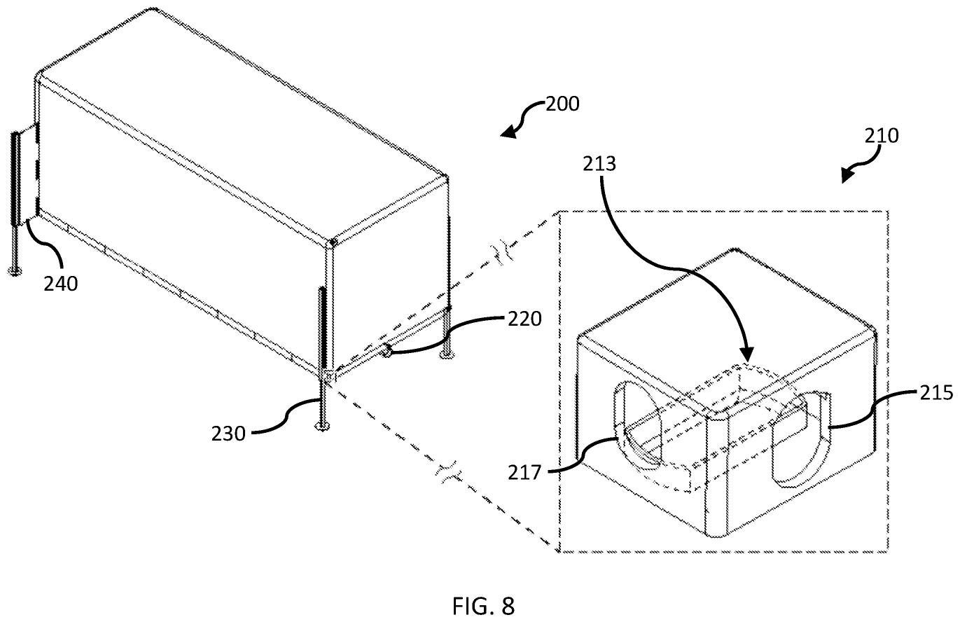

FIGS. 5-7 illustrate an example enclosed trailer 200. Enclosed trailer 200 includes a number of corner castings configured to selectively and securely couple with locks 110 of chassis 100. FIG. 8 illustrates a perspective view of the example enclosed trailer 200 of FIGS. 5-7 with a detail view of an example corner casting 210. Corner castings 210 may take the form of rectangular prisms each having top, bottom, left side, right side, front and rear surfaces with a number of openings in the surfaces. There may be a first opening 213 in the top or bottom surface, a second opening 215 in the left or right surface and a third opening 217 in the front or rear surface. In an example, one of the openings is a stacking hole, one of the openings is a stadium hole and one of the openings is a shield hole.

While only one corner casting is illustrated in FIG. 8, any number of corner castings suitable for matching with locks 110 of chassis 100 may be provided. In an example, four corner castings are provided. Among the other corner castings 210 provided to enclosed trailer 200, openings 215 and 217 may be provided in different orientations from that shown in detail in FIG. 8 in accordance with an orientation suitable for opening 213 to mate and/or engage with cone 113 of lock 110. For example, a corner casting provided to the front left corner of enclosed trailer 200 may be oriented such that opening 217 is directed forward and opening 215 is directed towards the left side, a corner casting provided to the front right corner of enclosed trailer 200 may be oriented such that opening 215 is directed forward and opening 217 is directed towards the right side and a corner casting provided to the rear right corner of enclosed trailer 200 may be oriented such that opening 217 is directed rearward and opening 215 is directed towards the right side.

A second component 220 of the sliding dovetail joint referred to above with reference to chassis 100 and FIGS. 1-4 is provided to a bottom surface of enclosed trailer 200 and is configured to engage with first component 120 to selectively prevent rotation and two directions of translation of enclosed trailer 200 relative to support surface 160 of chassis 100. In an example, to effectively engage with first component 120, second component 220 is also oriented in the direction of a longitudinal axis of enclosed trailer 200.

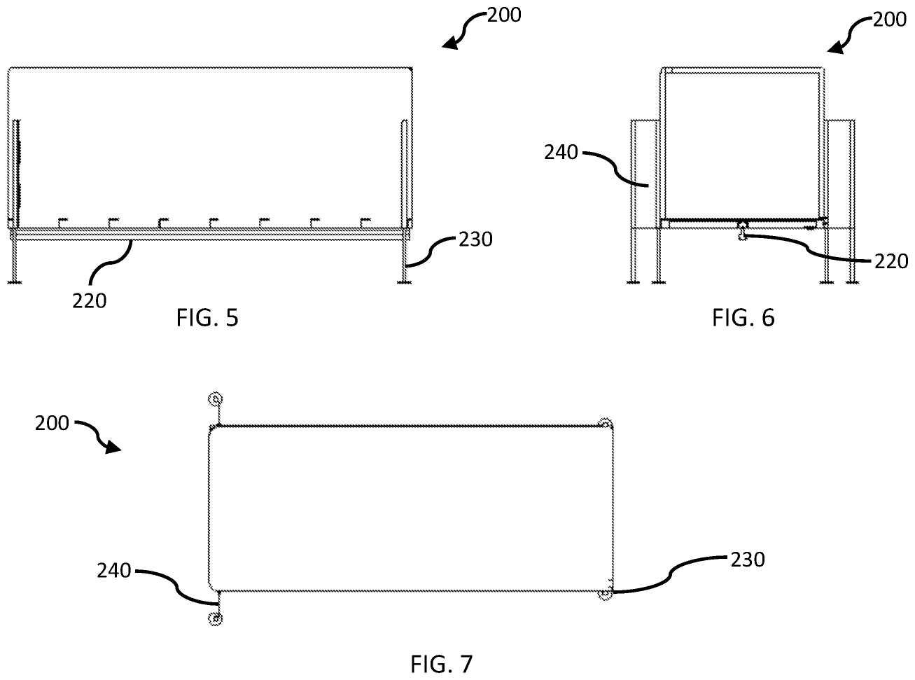

While first component 120 (FIG. 3) is depicted as a slot, it may be either of a slot or rail provided to support surface 160 of chassis 100 and, while second component 220 (FIG. 6) is depicted as a rail, it may be either of the matching one of a rail and a slot provided to a bottom surface of enclosed trailer 200. The slot is configured to receive the rail and promote alignment of enclosed trailer 200, with the chassis. In a further example, the rail includes extruded steel with a thickness of about ⅛″.

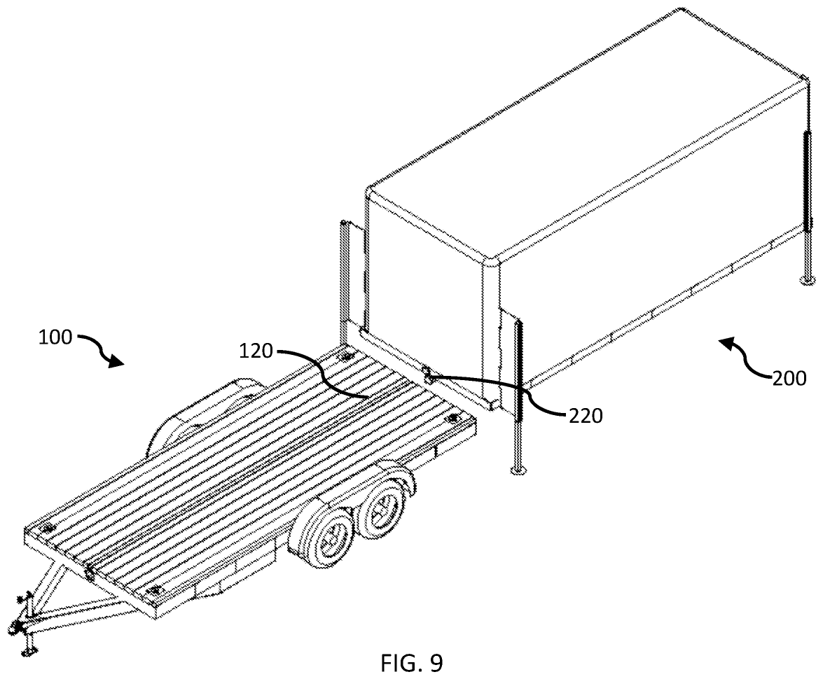

FIG. 9 illustrates a perspective view of the example enclosed trailer 200 of FIGS. 5-8 and the example chassis of FIGS. 1-4 in an alignment suitable for coupling.

Enclosed trailer 200 includes a number of stanchions 230 configured for supporting the enclosed trailer above support surface 160 of chassis 100 or above the ground in the absence of chassis 100. In an example, stanchions 230 are adjustable in length/height between a higher setting when the chassis is being maneuvered under the enclosed trailer and a lower setting when the enclosed trailer is supported by the chassis. Stanchions 230 may be up to 12 ft. in length/height.

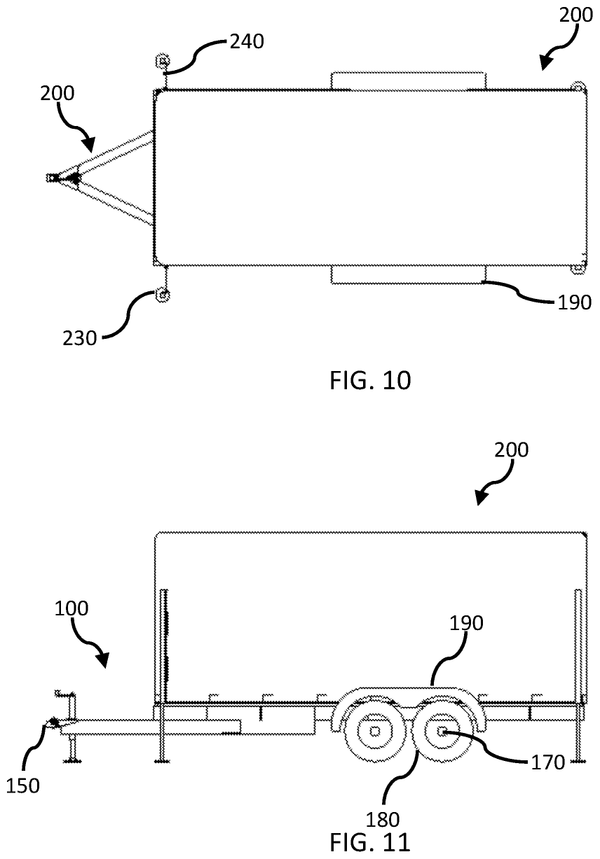

In an example, a first pair of stanchions 230 is separated by a first width and a second pair of stanchions 230 is spaced from the first pair of stanchions 230 and separated by a second width different from the first width. In an example, a distance between each stanchion of the first pair of stanchions 230 is greater than a width of the chassis at fenders 190 as enabled by wings 240. In another example, stanchions 230 are adjustable in width/spacing between a wider width when chassis 100 is being maneuvered under enclosed trailer 200 and a narrower setting when the enclosed trailer is supported by chassis 100. FIGS. 10-13 illustrate the example enclosed trailer 200 of FIGS. 5-8 mounted on the example chassis 100 of FIGS. 1-4.

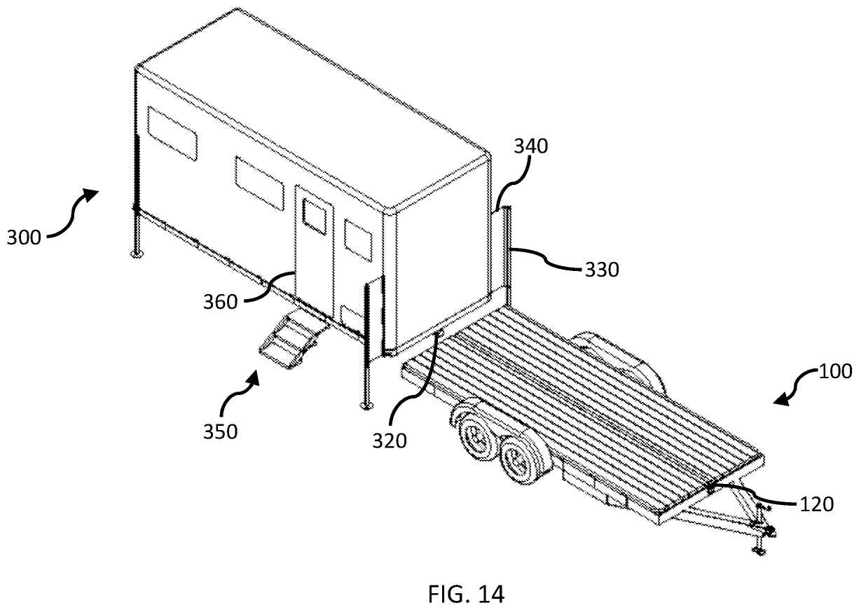

FIG. 14 illustrates a perspective view of an example camper 300 and the example chassis 100 of FIGS. 1-4 in an alignment suitable for coupling. Camper 300 also includes a number of corner castings (not visible) configured to selectively and securely couple with locks 110 of chassis 100. As above, the corner castings may take the form of rectangular prisms each having top, bottom, left side, right side, front and rear surfaces with a number of openings in the surfaces. There may be an opening in the top or bottom surface, an opening in the left or right surface and an opening in the front or rear surface. In an example, one of the openings is a stacking hole, one of the openings is a stadium hole and one of the openings is a shield hole. In a further example, the corner castings of camper 300 are identical to those of enclosed trailer 200.

While no corner casting is explicity illustrated in FIG. 14, any number of corner castings suitable for matching with locks 110 of chassis 100 may be provided. In an example, four corner castings are provided. Among the corner castings provided to camper 300, the openings from that shown in detail in FIG. 8 in accordance with an orientation suitable for an elongated opening to mate and/or engage with cone 113 of lock 110.

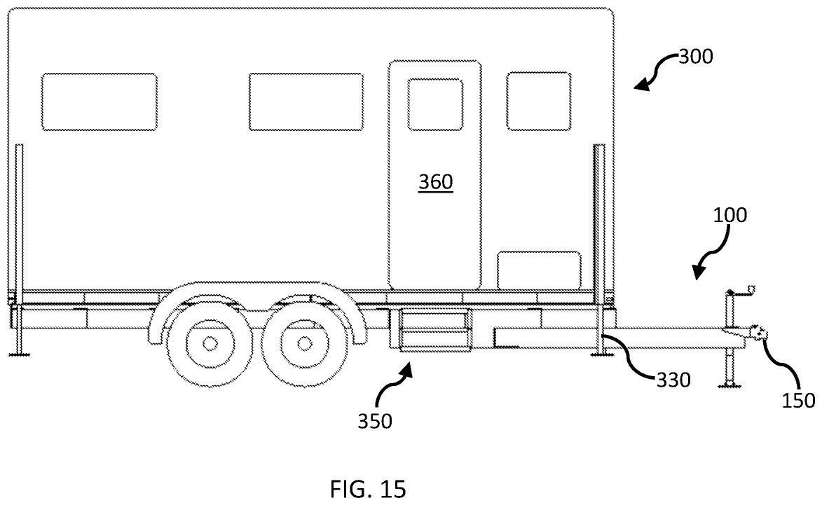

Camper 300 also includes a second component 320 of the sliding dovetail joint referred to above with reference to chassis 100 and FIGS. 1-4 provided to a bottom surface of camper 300 and configured to engage with first component 120 (FIG. 3) to selectively prevent rotation and two directions of translation of camper 300 relative to support surface 160 of chassis 100. FIG. 15 illustrates a side view of camper 300 mounted on the example chassis 100 of FIGS. 1-4. In an example, to effectively engage with first component 120, second component 320 is also oriented in the direction of a longitudinal axis of camper 300.

Camper 300 includes a number of stanchions 330 configured for supporting the camper above support surface 160 of chassis 100 or above the ground in the absence of the chassis. In an example, a distance between each stanchion of a first pair of stanchions 330 is greater than a width of chassis 100 at fenders 190 as enabled by wings 340. Camper 300 may further include detachable steps 350.

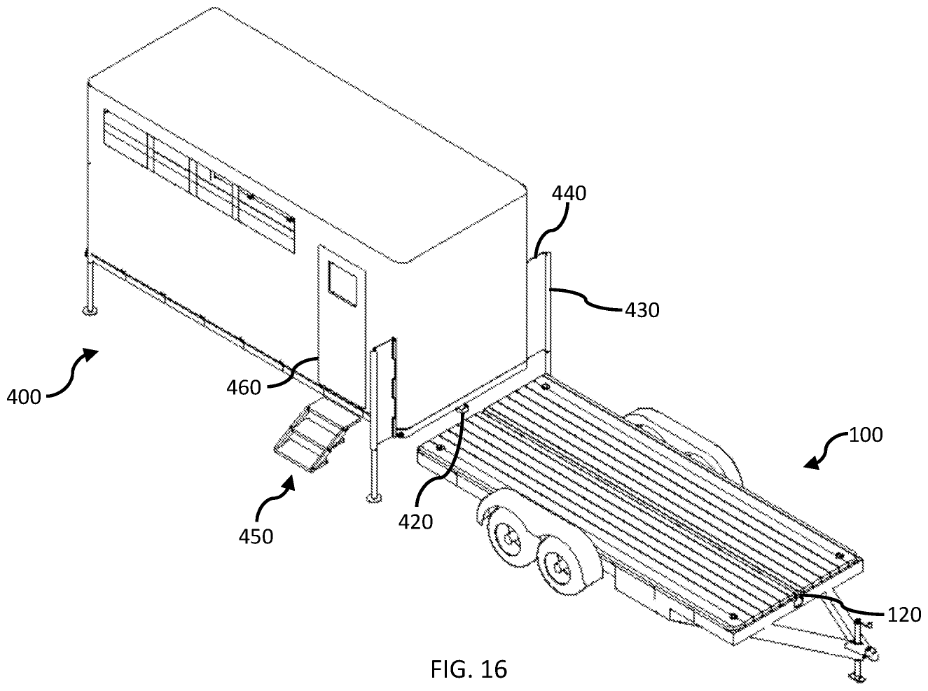

In an example, a first pair of stanchions 330 is separated by a first width and a second pair of stanchions 330 is spaced from the first pair of stanchions 330 and separated by a second width different from the first width. In an example, a distance between each stanchion of the first pair of stanchions 330 is greater than a width of chassis 100 at fenders 190 as enabled by wings 340. In another example, stanchions 330 are adjustable in width/spacing between a wider width when chassis 100 is being maneuvered under camper 300 and a narrower setting when camper 300 is supported by chassis 100. FIG. 16 illustrates a perspective view of an example livestock trailer 400 and the example chassis 100 of FIGS. 1-4 in an alignment suitable for coupling.

Livestock trailer 400 also includes a number of corner castings (not visible) configured to selectively and securely couple with locks 110 of chassis 100. As above, the corner castings may take the form of rectangular prisms each having top, bottom, left side, right side, front and rear surfaces with a number of openings in the surfaces. There may be an opening in the top or bottom surface, an opening in the left or right surface and an opening in the front or rear surface. In an example, one of the openings is a stacking hole, one of the openings is a stadium hole and one of the openings is a shield hole.

While no corner casting is explicity illustrated in FIG. 16, any number of corner castings suitable for matching with locks 110 of chassis 100 may be provided. In an example, four corner castings are provided. Among the corner castings provided to livestock trailer 400, the openings from that shown in detail in FIG. 8 in accordance with an orientation suitable for an elongated opening to mate and/or engage with cone 113 of lock 110.

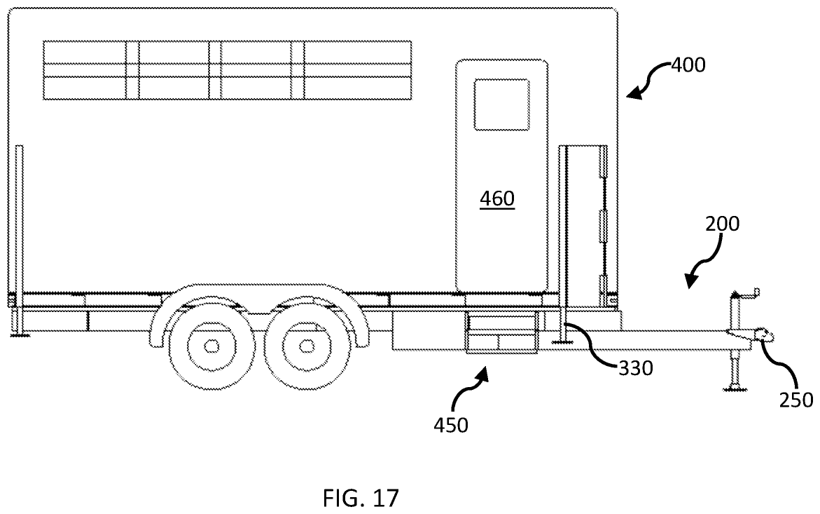

Livestock trailer 400 also includes a second component 420 of the sliding dovetail joint referred to above provided to a bottom surface of the livestock trailer and is configured to engage with first component 120 to selectively prevent rotation and two directions of translation of livestock trailer 400 relative to support surface 160 of chassis 100. FIG. 17 illustrates a side view of an example livestock trailer 400 mounted on the example chassis 100 of FIGS. 1-4. In an example, to effectively engage with first component 120, second component 420 is also oriented in the direction of a longitudinal axis of livestock trailer 400.

Livestock trailer 400 includes a number of stanchions 430 configured for supporting the livestock trailer above support surface 160 of chassis 100 or above the ground in the absence of the chassis. In an example, a distance between each stanchion of a first pair of stanchions 430 is greater than a width of chassis 100 at fenders 190 as enabled by wings 440.

In an example, a first pair of stanchions 430 is separated by a first width and a second pair of stanchions 430 is spaced from the first pair of stanchions 430 and separated by a second width different from the first width. In an example, a distance between each stanchion of the first pair of stanchions 430 is greater than a width of the chassis at fenders 190 as enabled by wings 440. In another example, stanchions 430 are adjustable in width/spacing between a wider width when chassis 100 is being maneuvered under livestock trailer 400 and a narrower setting when the livestock trailer is supported by chassis 100.

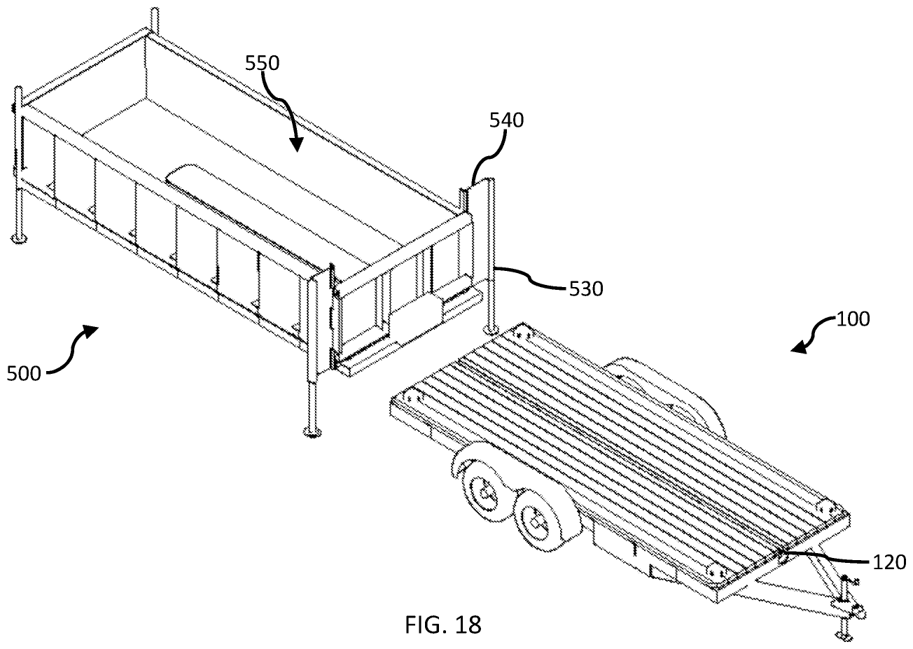

FIG. 18 illustrates a perspective view of an example dump bed 500 and the example chassis 100 of FIGS. 1-4 in an alignment suitable for coupling. Dump bed 500, which has payload container 550, also includes a number of corner castings (not visible) configured to selectively and securely couple with locks 110 of chassis 100. As above, the corner castings may take the form of rectangular prisms each having top, bottom, left side, right side, front and rear surfaces with a number of openings in the surfaces. There may be an opening in the top or bottom surface, an opening in the left or right surface and an opening in the front or rear surface. In an example, one of the openings is a stacking hole, one of the openings is a stadium hole and one of the openings is a shield hole.

While no corner casting is explicity illustrated in FIG. 18, any number of corner castings suitable for matching with locks 110 of chassis 100 may be provided. In an example, four corner castings are provided. Among the corner castings provided to dump bed 500, the openings from that shown in detail in FIG. 8 in accordance with an orientation suitable for an elongated opening to mate and/or engage with cone 113 of lock 110.

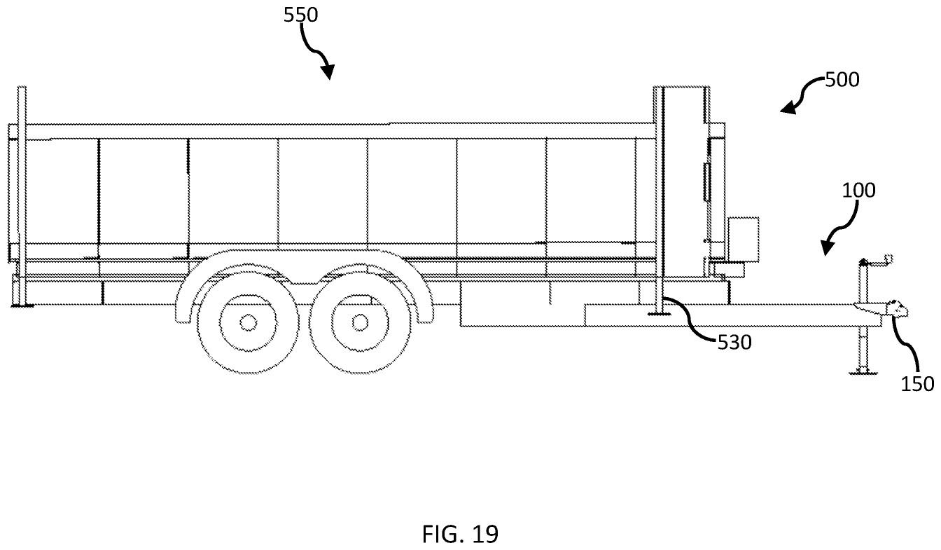

Dump bed 500 also includes a second component (not visible) of the sliding dovetail joint referred to above provided to a bottom surface of the dump bed and is configured to engage with first component 120 to selectively prevent rotation and two directions of translation of base 570 of dump bed 500 relative to support surface 160 of chassis 100. FIG. 19 illustrates a side view of an example dump bed 500 mounted on the example chassis 100 of FIGS. 1-4. In an example, to effectively engage with first component 120, the second component is also oriented in the direction of a longitudinal axis of dump bed 500.

Dump bed 500 includes a number of stanchions 530 configured for supporting the dump bed above support surface 160 of chassis 100 or above the ground in the absence of the chassis. In an example, a distance between each stanchion of a first pair of stanchions 530 is greater than a width of the chassis 100 at fenders 190 as enabled by wings 540.

In an example, a first pair of stanchions 530 is separated by a first width and a second pair of stanchions 530 is spaced from the first pair of stanchions 530 and separated by a second width different from the first width. In an example, a distance between each stanchion of the first pair of stanchions 530 is greater than a width of the chassis at fenders 190 as enabled by wings 540. In another example, stanchions 530 are adjustable in width/spacing between a wider width when chassis 100 is being maneuvered under dump bed 500 and a narrower setting when the dump bed is supported by chassis 100.

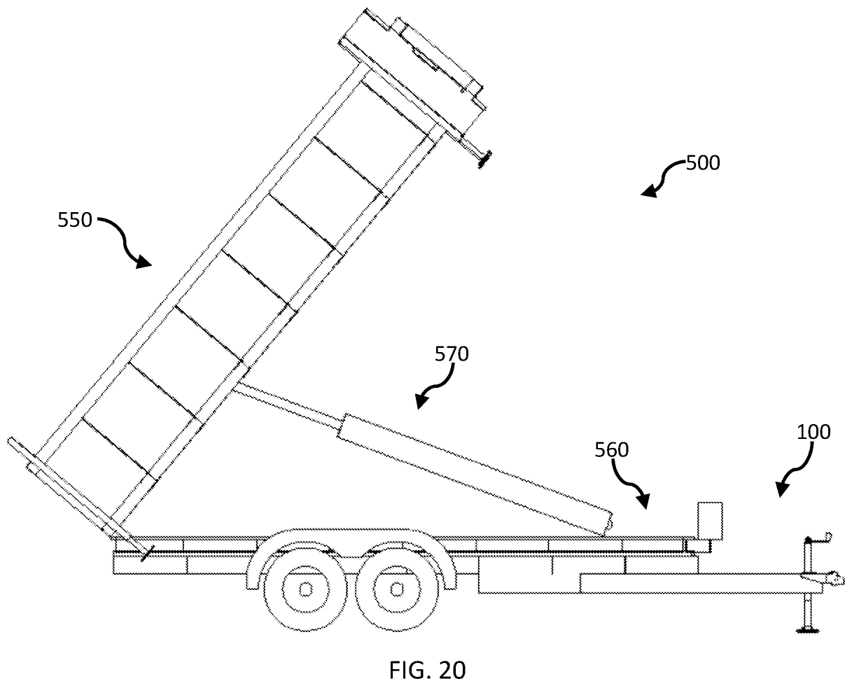

Dump bed 500 may further include a hydraulic ram 570 and a hydraulic ram control box. FIG. 20 illustrates a side view of an example dump bed 500 mounted on the example chassis 100 of FIGS. 1-4 and in a dumping configuration.

The configurable trailer system may additionally or alternatively include an open-sided trailer including a number of corner castings configured to selectively and securely couple with locks 110.

Disclosed example systems may be used in any of a variety of methods for configuring a trailer system. In an example method, a chassis supported by one or more axles and including a support surface is provided. At corners of the support surface, a plurality of locks are provided. A first one of an enclosed trailer, camper, livestock trailer, dump bed or open-sided trailer is placed onto the support surface. The first one of the enclosed trailer, camper, livestock trailer, dump bed or open-sided trailer is locked to the chassis by engaging the locks with corner castings provided to corners of the first one of the enclosed trailer, camper, livestock trailer, dump bed or open-sided trailer.

The first one of the enclosed trailer, camper, livestock trailer, dump bed or open-sided trailer may be placed onto the support surface by, in part, aligning and mating a rail provided to a bottom surface of the first one of the enclosed trailer, camper, livestock trailer, dump bed or open-sided trailer with a slot provided to the support surface of the chassis. The slot of the chassis may be slid along the rail of the first one of the enclosed trailer, camper, livestock trailer, dump bed or open-sided trailer.

The first one of the enclosed trailer, camper, livestock trailer, dump bed and open-sided trailer to the chassis by may be locked by inserting a portion of each lock into an opening in the corner castings. In an example, a lever is twisted or shifted to rotate a cone.

Any electrical wiring may be connected between the chassis and the coupled enclosed trailer, camper, livestock trailer, dump bed or open-sided trailer. After the locking, a plurality of stanchions provided to the first one of the enclosed trailer, camper, livestock trailer, dump bed and open-sided trailer are retracted.

The first one of the enclosed trailer, camper, livestock trailer, dump bed and open-sided trailer may subsequently be unlocked from the chassis and a plurality of stanchions provided to the first one of enclosed trailer, camper, livestock trailer, dump bed and open-sided trailer may be extended to support the first one of the enclosed trailer, camper, livestock trailer, dump bed and open-sided trailer above the chassis when the chassis is moved away. Any electrical wiring may be disconnected prior to removing the first one of the enclosed trailer, camper, livestock trailer, dump bed and open-sided trailer from the chassis.

A second one of the enclosed trailer, camper, livestock trailer, dump bed and open-sided trailer, with stanchions extended, may be placed onto the support surface and locked to the chassis by engaging the locks with corner castings provided to corners of the second one of the enclosed trailer, camper, livestock trailer, dump bed and open-sided trailer. Placing the second one of the enclosed trailer, camper, livestock trailer, dump bed and open-sided trailer may further include sliding a slot along a rail. A plurality of stanchions provided to the second one of the enclosed trailer, camper, livestock trailer, dump bed and open-sided trailer are retracted.

Actions described above are only illustrative and other alternatives can also be provided where one or more actions are added, one or more actions are removed, or one or more actions are provided in a different sequence without departing from the scope of the claims herein.

Embodiments of the disclosure are susceptible to being used for various purposes, including, though not limited to, enabling users to engage in a variety of activities with a single trailer system.

Modifications to embodiments of the disclosure described in the foregoing are possible without departing from the scope of the disclosure as defined by the accompanying claims. Expressions such as “including”, “comprising”, “incorporating”, “consisting of”, “have”, “is” used to describe and claim disclosed features are intended to be construed in a non-exclusive manner, namely allowing for items, components or elements not explicitly described also to be present. Reference to the singular is also to be construed to relate to the plural.

What is claimed is:

1. A configurable trailer system, comprising:
a chassis supported by one or more axles and including:
a support surface; and
at corners of the support surface, a plurality of locks; and
any combination of an enclosed trailer, a camper, a livestock trailer, a dump bed and an open-sided trailer each including a plurality of rectangular prisms configured to selectively and securely couple with the locks.

2. The configurable trailer system as set forth in claim 1, further comprising a tow hitch coupler extending from the chassis.

3. The configurable trailer system as set forth in claim 1, wherein the one or more axles are dead axles.

4. The configurable trailer system as set forth in claim 1, further comprising:
a first component of a sliding dovetail joint provided to the chassis support surface; and
a second component of the sliding dovetail joint provided to each of the combination of enclosed trailer, camper, livestock trailer, dump bed and open-sided trailer and configured to engage with the first component to selectively prevent movement of the each of the combination of enclosed trailer, camper, livestock trailer, dump bed and open-sided trailer away from the support surface of the chassis.

5. The configurable trailer system as set forth in claim 1, further comprising:
a rail provided to a bottom surface of each of the combination of enclosed trailer, camper, livestock trailer, dump bed and open-sided trailer; and
a slot provided to the support surface of the chassis and configured to receive the rail and promote alignment of each of the combination of enclosed trailer, camper, livestock trailer, dump bed and open-sided trailer.

6. The configurable trailer system as set forth in claim 5, wherein the slot is provided in an orientation approximately perpendicular to the one or more axles.

7. The configurable trailer system as set forth in claim 1, wherein the locks comprise twist locks.

8. The configurable trailer system as set forth in claim 1, wherein the rectangular prisms comprise corner castings.

9. The configurable trailer system as set forth in claim 1, wherein the rectangular prisms further include a first opening in a top or bottom surface, a second opening in a side surface and a third opening in a front or rear surface.

10. The configurable trailer system as set forth in claim 1, wherein each of the combination of enclosed trailer, camper, livestock trailer, dump bed and open-sided trailer includes a plurality of stanchions configured for supporting each of the combination of enclosed trailer, camper, livestock trailer, dump bed and open-sided trailer above the support surface of the chassis or above the ground in the absence of the chassis.

11. A configurable trailer system, comprising:
a camper including a plurality of corner castings each having:
top, bottom, left side, right side, front and rear surfaces with a plurality of openings in the surfaces; and
a chassis supported by one or more axles and including:
a surface configured to support the camper; and
at corners of the surface, a plurality of locks configured to selectively and securely couple the camper to the chassis through engagement of the locks with the corner castings.

12. The configurable trailer as set forth in claim 11, further comprising a first component of a sliding dovetail joint provided to the support surface of the chassis and a second component of the sliding dovetail joint provided to a bottom surface of the camper.

13. The configurable trailer as set forth in claim 11, wherein the camper further comprises detachable steps.

14. The configurable trailer system as set forth in claim 11, further comprising a tow hitch coupler extending from the chassis.

15. The configurable trailer system as set forth in claim 11, wherein the one or more axles are dead axles.

16. A configurable trailer system, comprising:
a chassis supported by one or more axles and including:
a support surface; and
at corners of the support surface, a plurality of locks; and
a camper including a plurality of corner castings configured to selectively and securely couple with the locks.

17. The configurable trailer system as set forth in claim 16, further comprising a dump bed including a plurality of corner castings configured to selectively and securely couple with the locks.

18. The configurable trailer system as set forth in claim 17, further comprising an enclosed trailer including a plurality of corner castings configured to selectively and securely couple with the locks.

19. The configurable trailer system as set forth in claim 18, further comprising a livestock trailer including a plurality of corner castings configured to selectively and securely couple with the locks

20. The configurable trailer system as set forth in claim 19, further comprising a open-sided trailer including a plurality of corner castings configured to selectively and securely couple with the locks
